(19) United States
(12) Patent Application Publication
(10) Pub. No.: US 2010/0066054 A1
(43) Pub. Date: Mar. 18, 2010

(54) COLLAPSIBLE BICYCLE

(76) Inventor: I-Huang CHEN, Pateh City (TW)

Correspondence Address: Hershkovitz & Associates, LLC, 2845 Duke Street, Alexandria, VA, 22314, US

(21) Appl. No.: 12/233,112

(22) Filed: Sep. 18, 2008

(51) Int. Cl. B62K 15/00

(52) U.S. Cl. 280/278

(57) ABSTRACT

A collapsible bicycle has a frame assembly, a front wheel, a rear wheel assembly, a seat and a handle bar. The frame assembly has a head tube assembly, a downtube assembly, a seat tube assembly, a cross bar assembly, which are connected pivotally to each other. The front wheel and the handle bar are connected to the head tube assembly. the rear wheel assembly is connected to the downtube assembly. The seat is connected to the seat tube assembly. The downtube assembly has a front downtube and a rear downtube, which are connected pivotally to each other. The cross bar assembly has a front cross bar and a rear cross bar, which are connected detachably to each other. Therefore, the collapsible bicycle is folded and unfolded quickly without using any hand tools.

### BACKGROUND OF THE INVENTION

1. Field of the Invention

The present invention relates to a bicycle, especially to a collapsible bicycle that is easily carried.

2. Description of the Prior Arts

Bicycles are widely used for transportation and exercise, especially for short distance transportation. For example, commuters ride bicycles to travel from home to the public transportation and from the public transportation to the destination. Among the bicycles, the collapsible bicycles are popular because they are easily carried, transported and stowed when being collapsed.

However, the conventional collapsible bicycles need many disassembly or assembly steps to many parts when collapsing or unfolding. Sometimes, the hand tools also needs to disassemble or assemble the conventional collapsible bicycles. Therefore, the conventional collapsible bicycles are inconvenient for the users.

To overcome the shortcomings, the present invention provides a collapsible bicycle to mitigate or obviate the aforementioned problems.

### SUMMARY OF THE INVENTION

The main objective of the present invention is to provide a collapsible bicycle that is easily folded and unfolded. The collapsible bicycle has a frame assembly, a front wheel, a rear wheel assembly, a seat and a handle bar. The frame assembly has a head tube assembly, a downtube assembly, a seat tube assembly, a cross bar assembly, which are connected pivotally to each other. The front wheel and the handle bar are connected to the head tube assembly. the rear wheel assembly is connected to the downtube assembly. The seat is connected to the seat tube assembly. The downtube assembly has a front downtube and a rear downtube, which are connected pivotally to each other. The cross bar assembly has a front cross bar and a rear cross bar, which are connected detachably to each other. Therefore, the collapsible bicycle is folded and unfolded quickly without using any hand tools.

Other objectives, advantages and novel features of the invention will become more apparent from the following detailed description when taken in conjunction with the accompanying drawings.

### BRIEF DESCRIPTION OF THE DRAWINGS

FIG. 1 is a side view of a collapsible bicycle in accordance with the present invention;

FIG. 2 is an operational side view of the collapsible bicycle in FIG. 1 showing the rear cross bar being detached;

FIG. 3 is an operational side view of the collapsible bicycle in FIG. 1 showing the downtube being folded;

FIG. 4 is an operational side view of the collapsible bicycle in FIG. 1 showing fully collapsed;

FIG. 5 is an operational side view of the collapsible bicycle in FIG. 1 being mounted in the box;

FIG. 6 is an enlarged perspective view of the head tube assembly of the collapsible bicycle in FIG. 1;

FIG. 7 is an enlarged operational perspective view of the cross bar assembly of the collapsible bicycle in FIG. 1 showing the rear cross bar being detached; and

FIG. 8 is an enlarged perspective view of the seat tube assembly of the collapsible bicycle in FIG. 1.

### DETAILED DESCRIPTION OF THE PREFERRED EMBODIMENTS

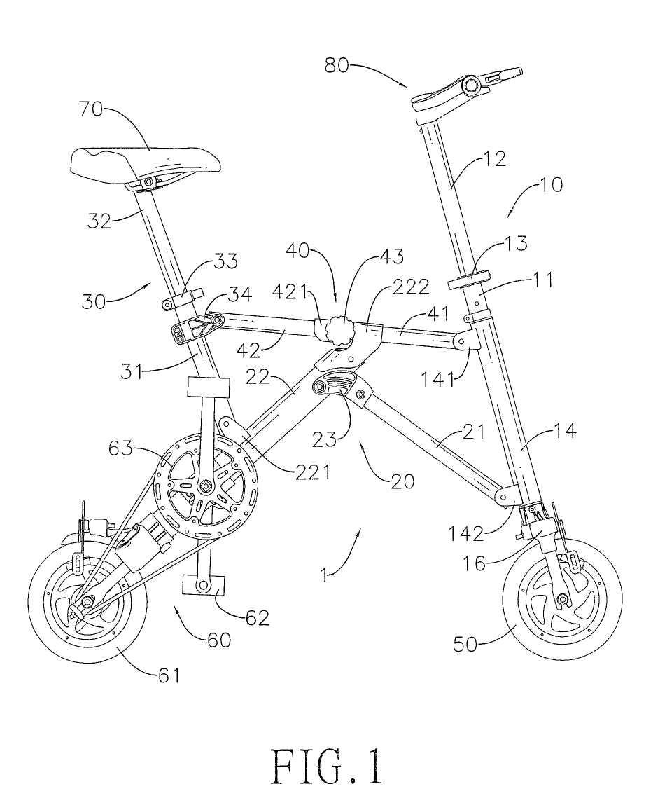

With reference to FIG. 1, a collapsible bicycle in accordance with the present invention comprises a frame assembly (1), a front wheel (50), a rear wheel assembly (60), a seat (70) and a handlebar (80).

The frame assembly (1) comprises a head tube assembly (10), a downtube assembly (20), a seat tube assembly (30) and a cross bar assembly (40).

The head tube assembly (10) has an outer head tube (14), a lower head tube (11), an upper head tube (12), a front quick release (13) and a fork (16). The outer head tube (14) has an upper end, a lower end, two upper pivoting wings (141) and two lower pivoting wings (142). The upper pivoting wings (141) are mounted oppositely on the upper end of the outer head tube (14). The lower pivoting wings (142) are mounted oppositely on the lower end of the outer head tube (14). The lower head tube (11) is mounted securely through and protrudes axially out from the outer tube (14) and has an upper end and a lower end. The upper head tube (12) is mounted slidably through the upper end of the lower head tube (11) and has an upper end. The front quick release (13) is mounted around the upper end of the lower head tube (11) and selectively locks the upper head tube (12) to keep the upper head tube (12) from sliding. The fork (16) is attached securely to the lower end of the lower head tube (14).

The downtube assembly (20) is connected pivotally to the head tube assembly (10) and has a front downtube (21), a rear downtube (22) and a lower pivoting sleeve (23).

The front downtube (21) is connected pivotally to the outer tube (14) of the head tube assembly (10) and has a front end and a rear end. The front end of the front downtube (21) is connected pivotally to the lower end of the outer head tube (14) of the head tube assembly (10) and may be connected pivotally to the lower pivoting wings (142).

The rear downtube (22) is connected pivotally to the front downtube (21) and has a front end, a rear end, an outer sidewall and two rear pivoting wings (221). The pivoting wings (221) are mounted oppositely on the rear end of the rear downtube (22).

The lower pivoting sleeve (23) is mounted around the rear end of the front downtube (21) and has two pivoting wings (231). The pivoting wings (231) are mounted pivotally on the outer sidewall of the rear downtube (22).

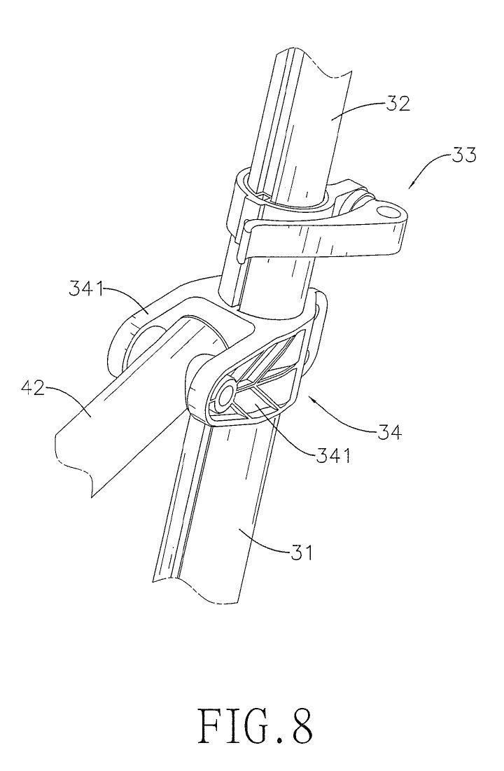

With reference to FIGS. 1 and 8, the seat tube assembly (30) is connected pivotally to the rear end of the rear downtube (22) of the downtube assembly (20) and has a lower seat tube (31), an upper seat tube (32), a rear quick release (33) and an upper pivoting sleeve (34). The lower seat tube (31) is connected pivotally to the rear end of the rear downtube (22) and has an upper end and a lower end. The lower end of the lower seat tube (31) is mounted pivotally between the rear pivoting wings (221) of the rear downtube (22). The upper seat tube (32) is mounted slidably through the upper end of the lower seat tube (31) and has an upper end. The rear quick release (33) is mounted around the upper end of the lower seat tube (31) and selectively locks the upper seat tube (32) to keep the upper seat tube (32) from sliding. The upper pivoting sleeve (34) is mounted around the lower seat tube (31) and has two pivoting wings (341).

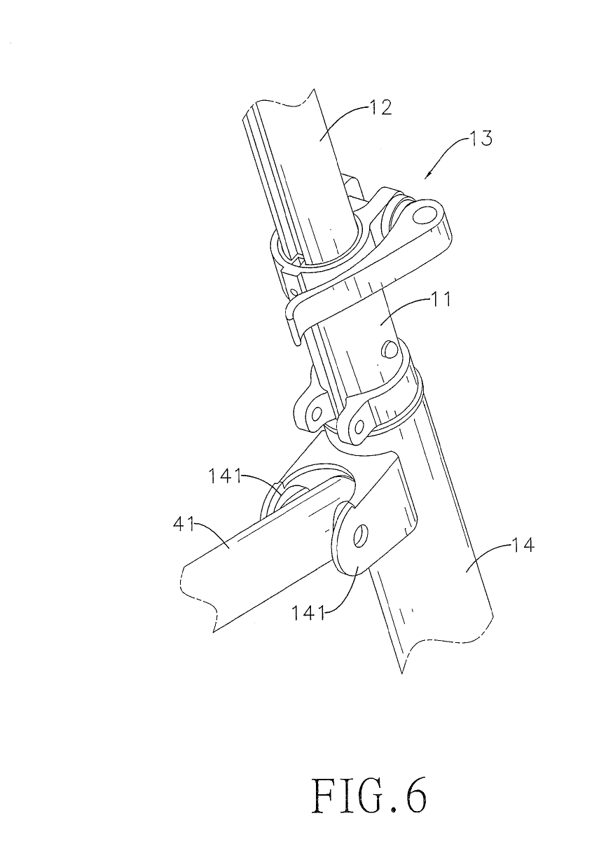

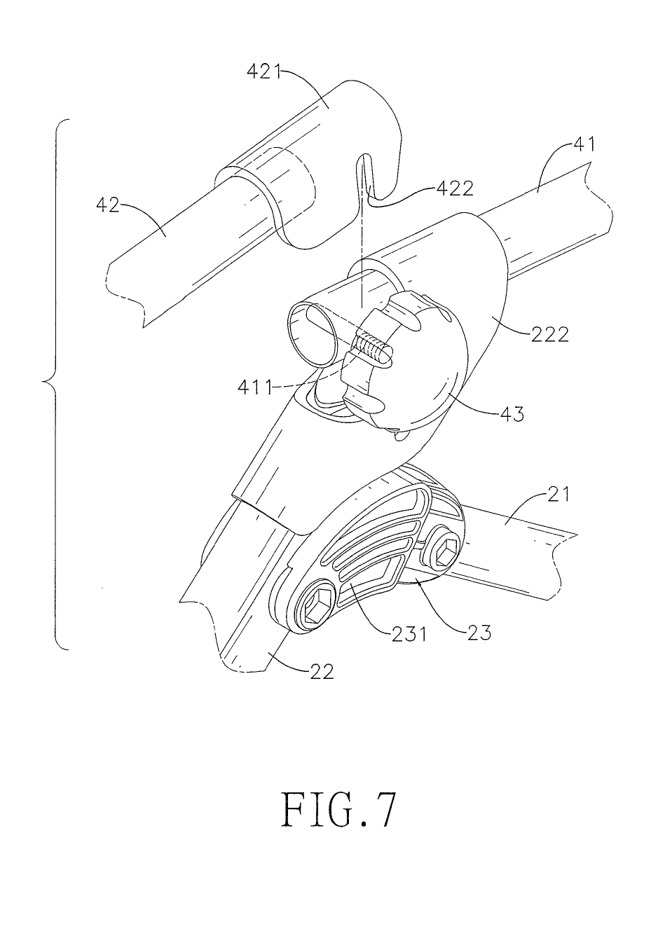

With reference to FIGS. 1 and 6 to 8, the cross bar assembly (40) is connected pivotally between the head tube assembly (10), the downtube assembly (20) and the seat tube assembly (30). The cross bar assembly (40) has a front cross bar (41), a mounting sleeve (222), a rear cross bar (42) and a fastener (43).

The front cross bar (41) is connected pivotally the outer tube (14) of the head tube assembly (10) and has a front end, a rear end and a pin (411). The front end of the front cross bar (41) is connected pivotally to the upper end of the outer tube (14) and may be mounted pivotally between upper pivoting wings (141) of the outer head tube (14). The pin (411) is mounted transversely through the rear end of the front cross bar (41) and may be a screw.

The mounting sleeve (222) is mounted securely around the front cross bar (41) near the rear end of the front cross bar (41) and is mounted pivotally on the front end of the rear downtube (22).

The rear cross bar (42) is connected pivotally to the seat tube assembly (30), is connected detachably to the front cross bar (41) and has a front end, a rear end and a joint (421). The rear end is connected pivotally to the seat tube assembly (30) and may be mounted between the pivoting wings (341) of the upper pivoting sleeve (34). The joint (421) is attached securely to the front end of the rear cross bar (42), is connected detachably to the front cross bar (41), is selectively clamped tightly on the rear end of the front cross bar (41) and has a notch (422). The notch (422) of the joint (421) selectively mounted around the pin (411).

The fastener (43) is mounted securely on the pin (411), selectively presses against the joint (421) to clamped tightly on the rear end of the front cross bar (41) and may be a nut.

The front wheel (50) is connected rotatably to the fork (16).

The rear wheel assembly (60) is connected to the rear downtube (22) and has a rear wheel (61), a crankset (63) and two pedals (62). The rear wheel (61) is connected rotatably to the rear downtube (22). The crankset (63) is connected to the rear wheel (61) and is connected to the rear downtube (22). The pedals (62) are connected oppositely to the crankset (63).

The seat (70) is attached securely to the seat tube assembly (30) and may be mounted securely on the upper end of the upper seat tube (32).

The handlebar (80) is connected to the head tube assembly (10) and has a connecting bar (81) and two pivoting bars (82). The connecting bar (81) is connected securely to the head tube assembly (10) and may be mounted securely in the upper end of the upper head tube (12). The pivoting bars (82) are oppositely mounted pivotally on the connecting bar (81).

With reference to FIG. 1, the collapsible bicycle as described is fully unfolded.

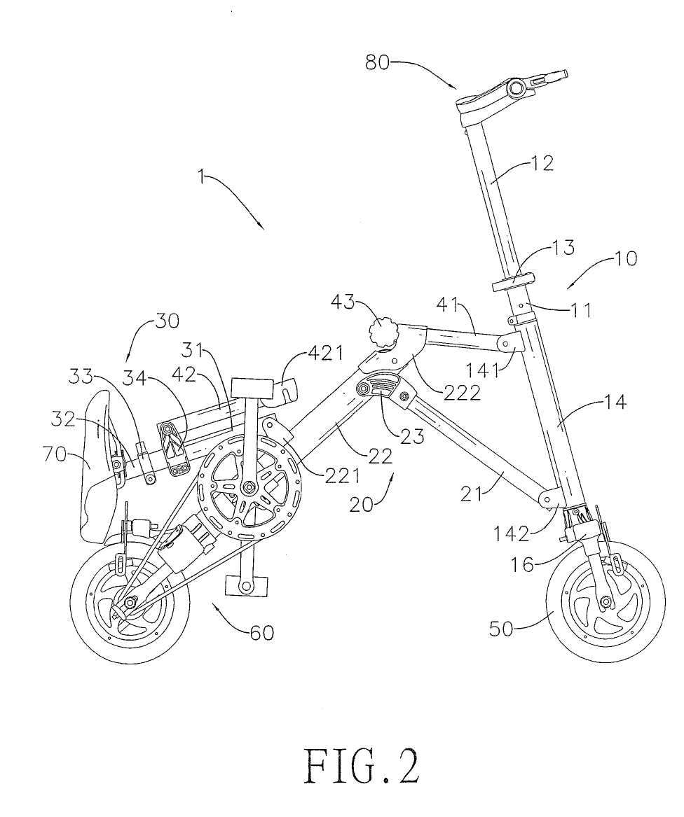

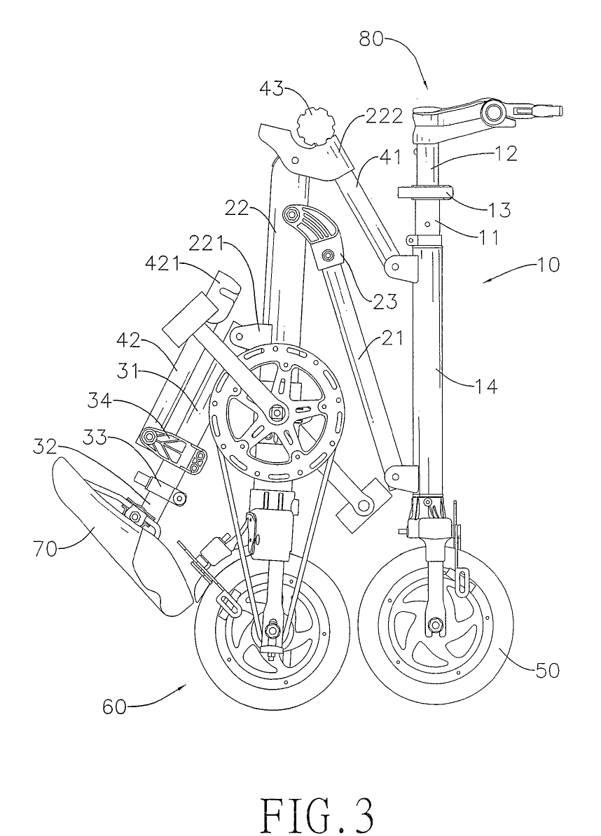

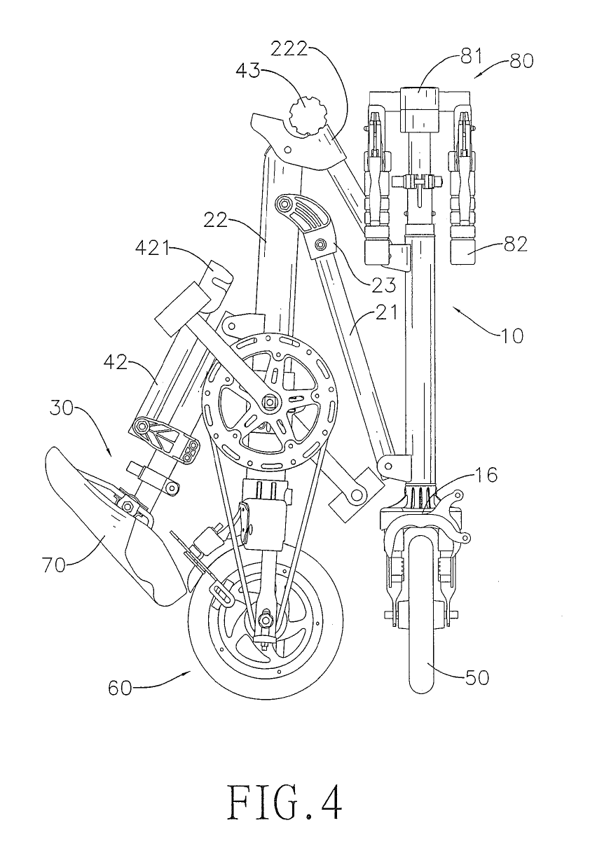

With reference to FIGS. 2 to 4 and 7, the collapsible bicycle as described is collapsed. The quick releases (13, 33) are loosen to allow the upper head tube (12) and the upper seat tube (32) to be retracted into the lower head tube (11) and the lower seat tube (31). The fastener (43) is rotated to loosen the joint (421) to detach the rear cross bar (42) from the front cross bar (41). The rear cross bar (42) and the lower seat tube (31) are pivoted to be parallel to each other. The front cross bar (41) and the front downtube (21) are pivoted to shorten the distance between the front and rear wheels (50, 61). Then the handlebar (80) and the head tube assembly (10) are pivoted and the pivoting bars (82) are also pivoted to reduce the collapsing volume of the collapsible bicycle as described. Therefore, the collapsible bicycle as described is fully collapsed easily.

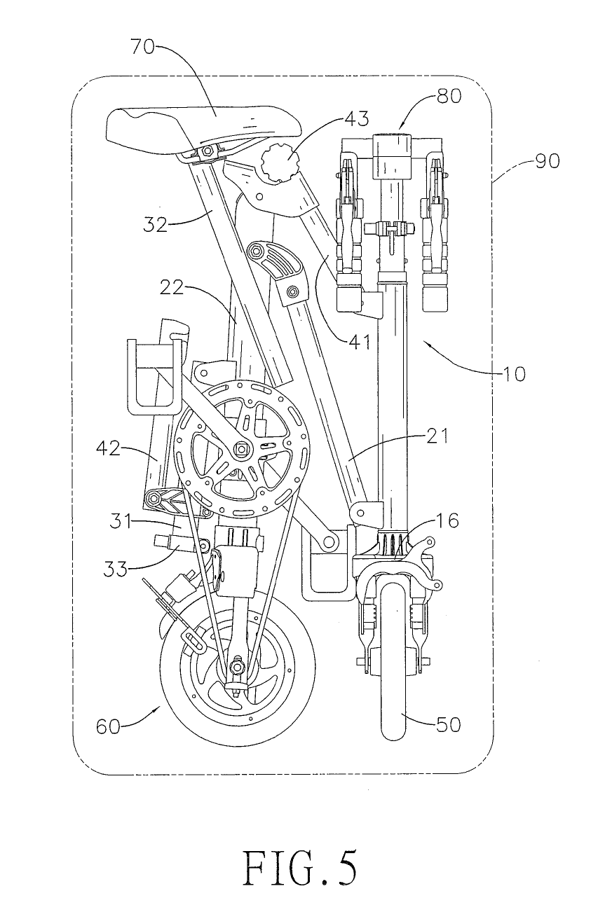

With further reference to FIG. 5, the upper seat tube (32) is fully slide out from the lower seat tube (31) to allow the lower seat tube (31) and the rear cross bar (42) to be pivoted parallel with the rear downtube (22). Therefore, the collapsible bicycle as described is small enough to be put into a box (90).

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A collapsible bicycle comprising:
a frame assembly comprising
a head tube assembly having
an outer head tube having an upper end and a lower end; and
a fork being attached securely to the lower end of the outer head tube;
a downtube assembly being connected pivotally to the head tube assembly and having
a front downtube being connected pivotally to the outer tube of the head tube assembly and having
a front end being connected pivotally to the lower end of the outer head tube of the head tube assembly; and
a rear end; and
a rear downtube being connected pivotally to the front downtube and having a front end, a rear end and an outer sidewall;
a seat tube assembly being connected pivotally to the rear end of the rear downtube of the downtube assembly; and
a cross bar assembly being connected pivotally between the head tube assembly, the downtube assembly and the seat tube assembly and having
a front cross bar being connected pivotally the outer tube of the head tube assembly and having
a front end being connected pivotally to the upper end of the outer tube; and
a rear end; and
a rear cross bar being connected pivotally to the seat tube assembly, being connected detachably to the front cross bar and having
a front end; and
a rear end being connected pivotally to the seat tube assembly;
a front wheel being connected rotatably to the fork;
a rear wheel assembly being connected to the rear downtube and having
a rear wheel being connected rotatably to the rear downtube;
a crankset being connected to the rear wheel and being connected to the rear downtube; and
two pedals being connected oppositely to the crankset;
a seat being attached securely to the seat tube assembly; and
a handlebar being connected to the head tube assembly.

2. The collapsible bicycle as claimed in claim 1, wherein
the front cross bar has a pin being mounted transversely through the rear end of the front cross bar;
the rear cross bar has a joint being attached securely to the front end of the rear cross bar, being connected detachably to the front cross bar, being selectively clamped tightly on the rear end of the front cross bar and having a notch being selectively mounted around the pin; and
the cross bar assembly has
a mounting sleeve being mounted securely around the front cross bar near the rear end of the front cross bar and being mounted pivotally on the front end of the rear downtube; and
a fastener being mounted securely on the pin and selectively presses against the joint.

3. The collapsible bicycle as claimed in claim 1, wherein
the head tube assembly has
a lower head tube being mounted securely through and protrudes axially out from the outer tube and having an upper end and a lower end;
an upper head tube being mounted slidably through the upper end of the lower head tube and having an upper end;
a front quick release being mounted around the upper end of the lower head tube and selectively locking the upper head tube;
the seat tube assembly has
a lower seat tube being connected pivotally to the rear end of the rear downtube and having an upper end and a lower end;
an upper seat tube being mounted slidably through the upper end of the lower seat tube and having an upper end; and
a rear quick release being mounted around the upper end of the lower seat tube and selectively locking the upper seat tube; and
the seat is mounted securely on the upper end of the upper seat tube.

4. The collapsible bicycle as claimed in claim 2, wherein
the head tube assembly has
a lower head tube being mounted securely through and protrudes axially out from the outer tube and having an upper end and a lower end;
an upper head tube being mounted slidably through the upper end of the lower head tube and having an upper end;
a front quick release being mounted around the upper end of the lower head tube and selectively locking the upper head tube;
the seat tube assembly has
a lower seat tube being connected pivotally to the rear end of the rear downtube and having an upper end and a lower end;
an upper seat tube being mounted slidably through the upper end of the lower seat tube and having an upper end; and
a rear quick release being mounted around the upper end of the lower seat tube and selectively locking the upper seat tube; and
the seat is mounted securely on the upper end of the upper seat tube.

5. The collapsible bicycle as claimed in claim 1, wherein
the outer head tube has
two upper pivoting wings being mounted oppositely on the upper end of the outer head tube; and
two lower pivoting wings being mounted oppositely on the lower end of the outer head tube;
the front end of the front downtube is connected pivotally to the lower pivoting wings;
the rear downtube has two pivoting wings being mounted oppositely on the rear end of the rear downtube;
the downtube assembly has a lower pivoting sleeve being mounted around the rear end of the front downtube and having two pivoting wings being mounted pivotally on the outer sidewall of the rear downtube; and
the front end of the front cross bar is mounted pivotally between upper pivoting wings of the outer head tube.

6. The collapsible bicycle as claimed in claim 4, wherein
the outer head tube has
two upper pivoting wings being mounted oppositely on the upper end of the outer head tube; and
two lower pivoting wings being mounted oppositely on the lower end of the outer head tube;
the front end of the front downtube is connected pivotally to the lower pivoting wings;
the rear downtube has two pivoting wings being mounted oppositely on the rear end of the rear downtube;
the downtube assembly has a lower pivoting sleeve being mounted around the rear end of the front downtube and having two pivoting wings being mounted pivotally on the outer sidewall of the rear downtube;
the seat tube assembly has an upper pivoting sleeve being mounted around the lower seat tube and having two pivoting wings;
the lower end of the lower seat tube is mounted pivotally between the rear pivoting wings of the rear downtube;
the front end of the front cross bar is mounted pivotally between upper pivoting wings of the outer head tube; and
the rear end of the rear cross bar is mounted between the pivoting wings of the upper pivoting sleeve.

7. The collapsible bicycle as claimed in claim 1, wherein the handle bar has
a connecting bar being connected securely to the head tube assembly; and
two pivoting bars being oppositely mounted pivotally on the connecting bar.

8. The collapsible bicycle as claimed in claim 6, wherein the handle bar has
a connecting bar being mounted securely in the upper end of the upper head tube; and
two pivoting bars being oppositely mounted pivotally on the connecting bar.

9. The collapsible bicycle as claimed in claim 2, wherein
the pin is a screw; and
the fastener is a nut.

10. The collapsible bicycle as claimed in claim 8, wherein
the pin is a screw; and
the fastener is a nut.
